(19) United States
(12) Patent Application Publication
(10) Pub. No.: US 2003/0154998 A1
(43) Pub. Date: Aug. 21, 2003

(54) Texturized dental floss

(76) Inventors: Alexandre Petrocini Falleiros, Sao Jose dos Campos SP (BR); Emilson Ismael Netto, Jacarei SP (BR); Luiz Bellino Simionato, Sao Jose dos Campos SP (BR)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 10/257,490

(22) PCT Filed: Apr. 17, 2001
(86) PCT No.: PCT/BR01/00050

(30) Foreign Application Priority Data
Apr. 20, 2000 (BR) PI 0001250-5

(51) Int. Cl. A61C 15/00

(52) U.S. Cl. 132/321; 132/329

(57) ABSTRACT

A texturized dental floss formed of a bundle of texturized filaments (1) and comprising, in each floss extension unit: cleaning portions (10) having a determined longitudinal extension and circumferential contour, which are previously defined in the bundle of texturized filaments (1); and fastening portions (20), each being provided between two consecutive adjacent cleaning portions (10), having a determined longitudinal extension in which the filaments are cohered and contained in a circumferential contour, which is substantially reduced in relation to that of the cleaning portion (10), said fastening portions (20) being provided in order to maintain substantially unaltered the elasticity and flexibility characteristics of the bundle of filaments (1).

### FIELD OF THE INVENTION

The present invention refers to a texturized dental floss and, more particularly, to texturized threads and tapes, for inter-dental cleaning, usually for removing the food debris retained in the interproximal dental regions.

### BACKGROUND OF THE INVENTION

A known solution of dental floss (or tape) comprises a yarn of filaments of cotton, silk or any other polymer material, which is coated, for example, by impregnation of an additive composition containing wax.

However, despite its good lubricant characteristics, due to the threaded, thus cohesive arrangement of its filaments, this dental floss does not have anchoring points, which permit an efficient pickup and consequent removal of the food residues from the inter-proximal dental regions.

In order to overcome the limitations of this type of floss, the so-called texturized dental flosses have been developed, in which the filaments are unwound and then impregnated with the additive composition. Besides having the advantage of incorporating substantially higher amounts of the additive composition in the inter-filamentary spaces, providing a final product with higher antiseptic and therapeutic capacity, these known texturized flosses have a higher contact surface with the inter-proximal surfaces of the teeth, as well as a good capacity for removing the food residues, which are retained in the interstices of the filaments, which filaments are maintained loose, although aggregated to each other by action only of the additive composition.

However, it has been verified that in such texturized flosses there is a higher occurrence of shredding (which may occur due to narrow inter-dental regions, to irregularities existing in these regions, and to the way the dental floss is used), mainly when the user has very small inter-dental distances and/or irregularities in the inter-proximal dental regions in which the floss may kink.

### DISCLOSURE OF THE INVENTION

Thus, it is an object of the present invention to provide a dental floss, which is multi-filamentary and texturized, of easy processing and packaging, and which combines the characteristics of a high removing capacity in the inter-dental regions with a reduced degree of shredding of its filaments, independently of the existing inter-dental distances.

This and other objectives and advantages of the present invention are achieved by providing a texturized dental floss, for inter-dental hygiene and/or therapy, of the type formed of a bundle of texturized filaments and comprising, in each floss extension unit: cleaning portions having a determined longitudinal extension and a circumferential contour, which are previously defined in the bundle of texturized filaments; and fastening portions, each being provided between two consecutive adjacent cleaning portions, having a determined longitudinal extension in which the filaments are cohered and contained in a circumferential contour that is substantially reduced in relation to that of the cleaning portion, said fastening portions being provided in order to maintain substantially unaltered the characteristics of elasticity and flexibility of the bundle of filaments.

### BRIEF DESCRIPTION OF THE DRAWINGS

The invention will be described below, with reference to the appended drawings, in which:

FIG. 1 illustrates, schematically and in an enlarged scale, a perspective view of a possible construction for the dental floss according to the present invention;

FIG. 2 is a lateral view of the dental floss of FIG. 1; and

FIG. 3 illustrates, schematically, an enlarged cross-sectional view of the dental floss, taken along line III-III of FIG. 2.

### BEST MODE OF CARRYING OUT THE INVENTION

The present invention refers to a texturized dental floss, to be used in inter-dental hygiene and/or therapy and consisting of a bundle of filaments 1 made of a texturizable material selected from cotton, silk, nylon, polyethylene, polypropylene, polyester, acrylic fibers, and mixtures of these materials.

The filaments of the bundle of filaments 1 are opened, through a texturizing treatment, preferably by heat, from a filamentary yarn, or basic thread, which is commercially available. A texturized floss is obtained with a certain circumferential contour and with a cross-section, which are previously determined as a function of the application to be given to the dental floss in terms of inter-dental distance.

In order to carry out the present invention, the bundle of filaments 1 is texturized so as to present a titer with a range between 500 and 1400 Dtex (meaning that, for each 10000 meters of filament, the weight of said filament should remain between 500 g and 1400 g).

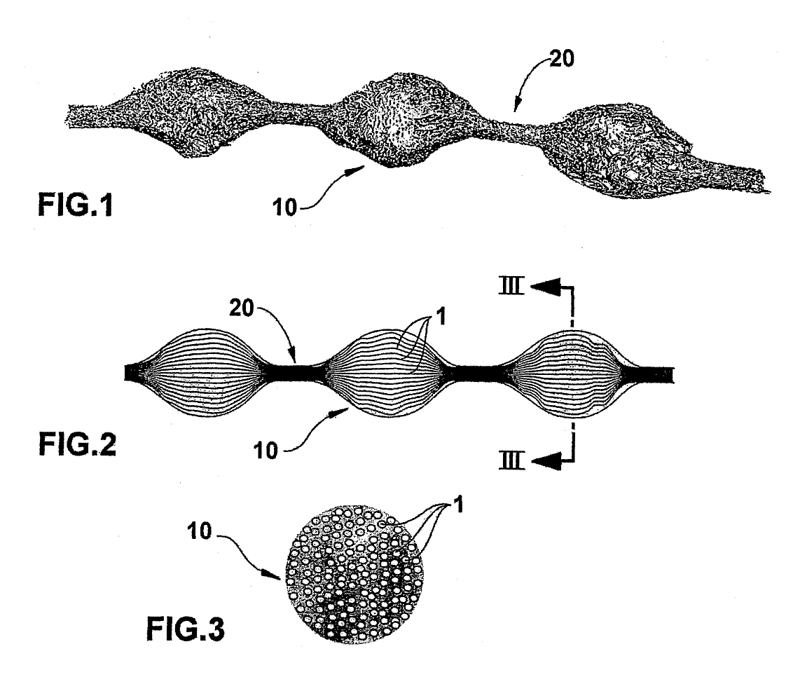

According to the illustrations of FIGS. 1-3, the texturized dental floss of the present invention comprises, in each floss extension unit: cleaning portions 10 having a determined longitudinal extension and circumferential contour, which are previously defined in the bundle of texturized filaments 1; and fastening portions 20, each being provided between two consecutive adjacent cleaning portions 10, having a determined longitudinal extension, in which the filaments are cohered and contained in a circumferential contour that is substantially reduced in relation to that of the cleaning portion 10, said fastening portions 20 being provided in order to maintain substantially unaltered the elasticity and flexibility characteristics of the bundle of filaments 1.

Each fastening portion 20 is defined by circumferential contraction of a respective longitudinal extension of the bundle of filaments 1, for example, by a tangling process, which reduces the circumferential contour of the dental floss to a value and with an occurrence per floss extension unit, which are defined in order to determine a substantial reduction in the shredding potential of the floss.

According to the present invention, each floss extension unit has a number of cleaning portions 10 and fastening portions 20 defined so as to minimize the detachment or rupture of the filaments of the dental floss. In one way of carrying out the invention, each floss extension unit has about 50% of its longitudinal extension provided with fastening portions 20, which results, consequently, in about 50% of reduction in the shredding potential for this floss.

The provision of fastening portions 20 being intercalated with the cleaning portions 10 in the bundle of filaments 1 minimizes in the dental floss the occurrence of shredding of its filaments 1, by minimizing the regions of in which they are free to move radially along the extension of the dental floss. As the dental floss is applied, the fastening means 20 avoid the detachment of loose ends, including those ends that become loose during flossing, and simultaneously capture the food residues in the interstices of the filaments.

While only one embodiment for the dental floss designed solely to promote inter-dental hygiene according to the present invention has been illustrated, it should be understood that other constructions are possible within the inventive scope presented herein.

1. A texturized dental floss formed of a bundle of texturized filaments (1), characterized in that it comprises, in each floss extension unit: cleaning portions (10) having a determined longitudinal extension and circumferential contour, which are previously defined in the bundle of texturized filaments (1); and fastening portions (20), each being provided between two consecutive adjacent cleaning portions (10), having a determined longitudinal extension in which the filaments are cohered and contained in a circumferential contour, which is substantially reduced in relation to that of the cleaning portion (10), said fastening portions (20) being provided in order to maintain substantially unaltered the elasticity and flexibility characteristics of the bundle of filaments (1) each fastening portion (20) being defined by a respective entangled and circumferentially contracted longitudinal extension of the bundle of filaments (1).

2. A texturized dental floss, as in claim 1, characterized in that the number of cleaning portions (10) and fastening portions (20) by floss extension unit is defined so as to minimize the detachment or rupture of the filaments of the dental floss.

3. A texturized dental floss, as in claim 1, characterized in that the bundle of filaments (1) is obtained from at least one of the materials selected from cotton, silk, nylon, polyethylene, polypropylene, polyester, and acrylic fibers.

4. A texturized dental floss, as in claim 1, characterized in that the texturized bundle of filaments (1) has a titer corresponding to a range between 500 Dtex and 1400 Dtex.
